(19) United States
(12) Patent Application Publication
(10) Pub. No.: US 2005/0164012 A1
(43) Pub. Date: Jul. 28, 2005

(54) Near infrared reflecting coatings on glass

(76) Inventors: Stephen W. Carson, Coatesville, PA (US); Glenn P. Florczak, East Brunswick, NJ (US); David A. Russo, Audubon, PA (US)

Correspondence Address: ARKEMA INC.;PATENT DEPARTMENT - 26TH FLOOR, 2000 MARKET STREET, PHILADELPHIA, PA, 19103-3222, US

(21) Appl. No.: 11/024,114

(22) Filed: Dec. 28, 2004

Related U.S. Application Data
(60) Provisional application No. 60/538,639, filed on Jan. 24, 2004.

(51) Int. Cl. B32B 17/06

(52) U.S. Cl. 428/432; 427/162

(57) ABSTRACT

Multi-layer solar control films composed of metal oxide, oxynitride, carbide, and/or oxycarbide layers are deposited on a substrate by atmospheric pressure chemical vapor deposition (APCVD). The film layers have alternating high/low refractive index. The coated substrate reflects near infrared (NIR) radiation, while transmitting a high level of visible radiation.

### This application claims benefit under 35 USC § 119 of U.S. provisional application Ser. No. 60/538,639, filed Jan. 23, 2004.

### FIELD OF THE INVENTION

This invention relates to a process for producing multi-layer solar control films that reflect the near infrared (NIR) portion of the solar spectrum. The films are applied by atmospheric pressure chemical vapor deposition (APCVD).

### BACKGROUND OF THE INVENTION

It is often desirable to reduce the amount of solar heat entering homes, offices, and vehicles through the windows. Currently, glass manufacturers achieve solar heat rejection either with colored glasses that absorb the heat rather than reflect it or with metal coatings that have high reflectivity in the visible as well as the near infrared regions of the spectrum. These types of glass usually have reduced visible transmittance, and the absorbing films will eventually re-radiate the captured energy at longer wavelengths, thereby heating up the room or car interior.

NIR reflective coatings reduce solar radiation by reflecting it and usually transmit a greater percentage of visible light than absorbing glasses. The primary benefit of a NIR reflective coating is a reduction in the amount of air conditioning needed. In the case of vehicles, a reduction in the size of the air conditioning unit is possible.

NIR films have been primarily prepared by sputter deposition processes, and also by liquid spray and immersion techniques. The sputtered films consist of as few as 3 to as many as 20 or more layers of oxides and/or nitrides and metals that are deposited at low deposition rates (<50 Å/min). The film stacks are generally composed of some combination of high/low refractive index materials at specific film thicknesses to maximize visible-transmission and NIR reflection while minimizing visible light reflection.

JP 4074737 describes the use of a sputter process to deposit a TIO₂ (85-100 nm)/silica (150-180 nm)/TiO₂ (85-100 nm) film stack with a visible transmission (% Tᵥᵢₛ) greater than 70 and a percent solar transmission (% Tₛₒₗ) of less than 60. JP 4133004 describes the use of electron beam vapor deposition, sputtering, spray or immersion to deposit zinc oxide (for UV reduction) and 6-10 layer film stacks. JP 2225345 describes the use of a sputter process to deposit a five layer stack of H/L/H/L/M with H=titania, L=silica, and M=tin oxide.

U.S. Pat. No. 5,073,451 describes the use of a sputter process to deposit 3 and 5 layer film stacks with a L/H/L index construction. The reference mentions a chemical vapor deposition (CVD) process without any examples. It also teaches an H/L/H construction with a refractive index (R.I.) for the L layer of 1.4-1.7 and the R.I. for the H layer of 1.8-2.5. EP 402075 describes a sputter process to produce a H/L/H film stack. U.S. Pat. No. 4,990,408 describes a sputter process for a H/L/H film stack with chromium oxide and chromium nitride as the H layers and an antimony-doped tin oxide as the L layer.

Metal film coatings for use as solar control films on glass windows generally are deposited by a sputtering process exemplified in U.S. Pat. No. 6,495,251, assigned to PPG Industries. This process is a batch operation done in a vacuum system where layers of a transparent dielectric/metal/dielectric are deposited atomistically along with other sacrificial metal, protective, and/or antireflective layers. The metal stacks can be repeated one or more times to enhance the near infrared (NIR) and mid-IR reflective properties of the glass. Although the coated glass has good low emissivity and solar control properties, however, the films are expensive to produce, are fragile, must be handled with special procedures, and are not chemically or oxidatively stable.

Metals also have been deposited by chemical vapor deposition processes that usually employ reduced pressure and/or plasma activation. Deposition of titanium metal by plasma assisted CVD is exemplified in U.S. Pat. No. 5,656,338, assigned to Roy Gordon, in which a solution of titanium tetrabromide in bromine is vaporized in an argon/hydrogen plasma. The same solution, both with and without the plasma, has also been used to deposit TiN or bilayer TiN-over-Ti metal coatings which are said to make low-resistance contact with a variety of materials. However, the solution used in this work is extremely corrosive and the use of plasma assisted CVD on a large scale is impractical.

Gordon and others also describe the APCVD of nitride films of Al, Ga, Sn, Si, V, Nb, Ta, and in using the amido derivatives and ammonia to obtain films of varying resistivity, solar transmission and reflection, M/N ratios and hydrogen content. See, U.S. Pat. No. 5178911, Chem. Mater., 2(5), 480 1990, 5(5), 614 (1993), J. Electrochem. Soc. 143(2), 736 (1996). However, deposition temperatures are generally <400° C., much too low for application in the float bath of a glass making line where temperatures range from 600-675° C.

Finally, the abstract of Japanese patent application JP 2000281387 describes the preparation of a multilayer heat shielding glass composed of fluorine doped tin oxide, titanium nitride and fluorine doped tin oxide. No details of the deposition of the film layers are given in this abstract, but subsequent abstracts and patents issued to the same assignee, Nippon Sheet Glass, describe a chemical vapor deposition process for depositing TiN from titanium tetrachloride, ammonia and nitrogen followed by an overcoated layer of either titanium, tin, or silicon dioxide in a separate and distinct step. In the case of titanium dioxide, a different precursor than the one used to deposit the nitride is employed.

Surprisingly it has now been found that a multi-layer, metal oxide NIR reflective coating can be deposited onto a glass substrate by means of an APCVD process. The band-pass filter film reflects and transmits in different parts of the spectrum, reflecting NIR and transmitting visible radiation. Advantageously the present invention provides NIR reflectance with as little as two layers, using inexpensive starting materials.

### SUMMARY OF THE INVENTION

It is accordingly a first objective of the invention to deposit a multi-layer, NIR-reflective coating onto a substrate by means of an APCVD process. Preferably all layers being metal oxide, oxynitride, carbide, and/or oxycarbide.

It is a second objective of the invention to produce a multi-layer film coating having an NIR reflectance of greater than 17 percent over the range 750-2500 nm, a visible transmission of greater than 70 percent, and a visible reflectance of less than 20 percent.

The objectives of the invention are achieved, in accordance with the principles of a preferred embodiment of the invention, by an APCVD process in which the substrate to be coated is placed in an inert atmosphere and heated to a float line temperature of between approximately 600-675° C. Successive gas mixtures composed of vaporized precursors and carrier gases are then fed through nozzles in the coating apparatus to deposit successive layers, depending on the oxygen content of the mixtures. The resulting coated substrate reflects at least 17 percent of the near infrared radiation over the range of 750-2500 nm.

### DETAILED DESCRIPTION OF THE INVENTION

The present invention involves the deposition by APCVD of multiple metal oxide, oxynitride, carbide, and/or oxycarbide layers to form an NIR reflective coating.

The APCVD process involves heating a substrate to a float line temperature in an inert atmosphere such as nitrogen. Depending on the specific material of the substrate, the temperature to which the substrate is heated will generally be between approximately 600 to 675° C., although it is possible that float line temperatures for certain glass or glass-like materials may be outside this range. The present invention is intended to include temperatures outside the range so long as they may be deemed to be float line temperatures for glass or glass-like substrates that have properties similar to glass.

In the second step, a gas mixture containing a precursor (MX) for a metal oxide, oxynitride, carbide, and/or oxycarbide layer is introduced into the apparatus containing the inert atmosphere and heated substrate.

In subsequent steps, gas mixtures containing a different MX precursor than in the previous layer are introduced into the coating apparatus. The MX precursor will be different that that previously introduced, but may be the same or different than other layers of the film stack. In one embodiment, doped metal oxide layers are formed. The layers of the film stack are chosen to provide alternating layers of high/low refractive index.

The resulting films are composed of 2 to 5 ( ) layers of metal oxides, metal carbides, metal oxynitrides, and/or metal oxycarbides of Si, Ti, Sn, Al, Ta, Zr, Zn. In a preferred embodiment, all of the film layers comprise metal oxides. Useful precursors include, but are not limited to silicon tetrachloride, tetraethoxysilane, tetramethylcyclotetrasiloxane, titanium tetrachloride, titanium tetraisopropoxide, tin tetrachloride, and monobutyltin trichloride. When alkoxide derivatives are used, deposition rates can be increased by the addition of Lewis acid accelerators such as alkyl phosphines, phosphates, and borates. When organotin halides are used, rates can be increased significantly by the use of controlled amounts of water. The precursors can be synthesized with specific ligands designed to decompose at lower temperatures or at faster rates. The ligand group consists of bulky groups including, but not limited to iso-butyl, tert-butyl, neopentyl, silylneopentyl; diketonates such as acac, fluorinated acac, heptane dionate, and tetramethyl heptanedionate; cyclopentadienyl and pentadienyl; alkylamido, amino-hyrido; mixtures thereof, and mixtures with halides.

The multiple film stacks can be formed using a single precursor, such as MBTC or SiH₄ by varying a small amount of an additive, such as SbCl₃ or by changing the deposition conditions from fully oxidizing (air, O₂) to partially reducing (N₂/H₂/air, NH₃/air, CO₂). Film stacks can be varied to optimize NIR reflectance, and also to reflect or absorb a significant portion of UV radiation, or to possess other low emissivity properties.

The multi-layer film stack preferably contains 2-5 layers. It has been shown that a film stack of 2 layers can be used to achieve good NIR reflection. In a preferred embodiment, the film stack consists of 3 layers.

The film stacks contain alternate layers of high and low refractive index, with all refractive indices between about 1.45 and 2.6. The thickness of each layer ranges form about 100 Å to about 2000 Å.

The film layers are deposited in a sequence designed to produce a NIR reflectance of greater than or equal to 17 percent over the range of 750-2500 nm, a visible transmission of greater than or equal to 70 percent, and a visible reflectance of greater than or equal to 20 percent.

The multi-layer film coating of the present invention can be deposited at rates usable in commercial processes. The deposition rate for the present process can be in the range of 400-500 Å/sec.

The substrate on which the multi-layer film is deposited can be any clear, hard substrate, capable of maintaining its form at the temperature of deposition. While glass is the preferred substrate, other materials including, but not limited to polymethylmethacrylate and polycarbonate may also be used.

The following examples are illustrated with titanium as the metal, but one in the art will realize that similar derivatives may be obtained using other metals and substituents, including but not limited to, Sn, Al, Ta, Zr, or Zn, as well as Ti(neopentyl)₄, Ti(neopentyl)₂Cl₂, Ti(t-butoxide)₄, Ti(I-propoxide)₂Cl₂, Ti(acac)₄, Cp,2,4-dimethylpentadienylTi, TiNMe₂)₄, and neopentylTiCl₃.

### EXAMPLES

### Example 1

Film stacks of the following compositions were deposited by the following APCVD process. The apparatus includes a standard APCVD set-up including a coating nozzle and an arrangement for moving the substrate beneath the coating nozzle to provide an even coating over the substrate. Because the apparatus is conventional, it is not illustrated or described in detail herein.

A 4×10 inch piece of soda lime silica (SLS) glass was heated on a hot nickel block to approximately 610° C. The heating apparatus and glass substrate were housed within a sealed, double-walled stainless steel flush box that was purged with nitrogen at 50 L/min for 15 min (corresponding to 5 turnovers of the box volume) to create an inert atmosphere within the coating environment. A gas mixture of 0.6 mol % titanium tetrachloride in 7.5 slpm nitrogen carrier gas at a temperature of 160° C. and, in a separately fed gas line, a reaction gas mixture of 1.8 mol % water in 7.5 slpm air at 160° C., were fed to the substrate surface via adjacent slots of a 5-slot coater. The titanium tetrachloride was introduced via the center slot and impinged on the glass surface with a face velocity of 0.97 m/s and the water/air reactant gas mixture was fed through the two slots immediately adjacent to the center slot, impinging on the glass surface with face velocity 0.48 m/s. The heating block and glass substrate were moved under the coater nozzle at a speed of 0.25 in/s using a stepping motor such that a dynamic coating 8 inches in length was achieved. The titanium tetrachloride and water feeds were discontinued and the block was returned to its home position.

Next, a gas mixture of 0.25 mol % of monobutyl tin chloride containing 5 wt. % antimony trichloride acid and 0.75 mol % water in 15 slpm dry air carrier gas at 160° C. were co-fed to the substrate surface via the outermost slots of the coating nozzle. This precursor mixture impinged on the substrate through the two slots with a face velocity of 0.97 m/s. Again the block and substrate were moved below the nozzle at a speed of 0.25 in/s over the same 8 in length, overcoating the TiO₂ layer with a layer of antimony-doped tin oxide.

In a final step, a second layer of TiO₂ was deposited on the tin oxide layer in the same manner as described above.

The optical properties of the film stack were measured using a Lambda 19 spectrophotometer and the refractive index and thickness of the layers was determined by measuring individual layers on a nkd 6000 spectrophotometer.

The following non-limiting film compositions were deposited in a similar manner. Each film composition is listed in TABLE 1 by:
a) Composition
b) Refractive Index=
c) Film thickness in Å
ATO=antimony doped tin oxide. The R.I. of the layer is controlled by the amount of
SbCl₃ added to the organotin precursor.
TiO₂=titanium dioxide
SiO₂=silicon dioxide
TO=tin oxide

Si=silicon

TABLE 1

| Film Composition | % Rₙᵢᵣ | % Tᵥᵢₛ | % Rᵥᵢₛ | % T_{UV} |
|---|---|---|---|---|
| TiO₂/ATO/TiO₂ | 28 | 71 | 12 | 27 |
| 2.45/1.75/2.45 | | | | |
| 950/950/950 | | | | |
| ATO/TiO₂/SiO₂/ATO | 31 | 84 | 14 | 49 |
| 1.85/2.45/1.46/1.85 | | | | |
| 400/900/1400/1100 | | | | |
| TiO₂/ATO/TiO₂ | 40 | 74 | 16 | 18 |
| 2.45/1.83/2.45 | | | | |
| 1100/800/1000 | | | | |
| ATO/SiO₂/ATO | 17 | 82 | 15 | 68 |
| 1.90/1.46/1.90 | | | | |
| 1300/1400/1200 | | | | |
| TiO₂/ATO | 29 | 75 | 15 | 36 |
| 2.45/1.68 | | | | |
| 1000/400 | | | | |

1. A process for producing a coated substrate which reflects the near infrared portion of the solar spectrum comprising depositing multiple film layers of metal-containing oxide, oxynitride, carbide and/or oxycarbide compounds onto a substrate by atmospheric pressure chemical vapor deposition, wherein said coated substrate reflects at least 17 percent of the near infrared radiation over the range of 750-2500 nm.

2. The process of claim 1 wherein the substrate is glass.

3. The process of claim 1 wherein said multilayer film comprises from 2 to 5 layers.

4. The process of claim 3 wherein said multilayer film comprises 3 layers.

5. The process of claim 1 wherein said films are comprised of metal oxides, metal carbides, metal oxynitrides, or oxycarbides of Si, Ti, Sn, Al, Ta, Zr, or Zn; or mixtures thereof.

6. The process of claim 5, wherein all film layers comprise metal oxides.

7. The process of claim 1 wherein at least one layer of the film comprises antimony-doped tin oxide.

8. The process of claim 1 wherein said coated substrate has a visible transmission of greater than about 70 percent, and visible reflectance of less than about 20 percent.

9. The process of claim 1 wherein each film layer has a refractive index of between 1.46 to 2.6.

10. The process of claim 1 wherein each film layer has a thickness of from 100 Å to 2000 Å.

11. The process of claim 1 wherein the deposition rate is up to 600 Å/sec.

12. The process of claim 11 wherein the deposition rate is from 400 to 500 Å.

13. A coated substrate comprising a substrate having directly deposited thereon multiple layers of metal oxide, oxynitride, carbide and/or oxycarbide films, wherein said coated substrate reflects at least 17 percent of the near infrared radiation over the range of 750-2500 nm, and has a visible transmission of greater than 70 percent and a visible reflectance of least than 20 percent.

14. The coated substrate of claim 13 wherein said multiple film layers are deposited by atmospheric pressure chemical vapor deposition.

15. The coated substrate of claim 13 wherein said multiple film layers comprise from 2 to 5 layers.
